(19) United States
(12) Patent Application Publication
(10) Pub. No.: US 2003/0167848 A1
(43) Pub. Date: Sep. 11, 2003

(54) Device for determining the change in the density of a medium

(76) Inventors: Eckard Glaser, Wurzburg (DE); Miroslaw Wrobel, Wurzburg (DE); Janet Grassmann, Eibelstadt (DE); Stergios Stergiopoulos, Toronto (CA)

Correspondence Address: Calvin P Griffith, Jones Day Reavis & Pogue, North Point, 901 Lakeside Avenue, Cleveland, OH, 44114, US

(21) Appl. No.: 10/089,277

(22) PCT Filed: Jan. 19, 2001
(86) PCT No.: PCT/EP01/00580

(30) Foreign Application Priority Data
Jul. 27, 2000 (DE) 100 36 567.1

(51) Int. Cl. G01N 29/02

(52) U.S. Cl. 73/597; 73/32 A

(57) ABSTRACT

The invention refers to a device for the detection of changes in the density of a solid, liquid or gaseous medium. The device is capable of detecting the effects of physical and/or chemical parameters, causing changes in the density and/or compression constants of the medium. The device comprises a transmitter unit for transmitting a send signal, having a constant frequency and amplitude and the send signal, comprising a minimum of one period, with a minimum of one receiver unit receiving the response signals reflected and/or transmitted from the medium. The transmitter and receiver units are coupled to the medium. The receiver unit is coupled to an A/D converter and a sampling device. The transmitter unit and the output of the A/D converter are coupled to a numerical processor for determination of the phase shift between the send signal and the receive signal, with the output being connected to a display. A memory may be used instead of a display.

The invention refers to a device for detecting changes in the density of a solid, liquid or gaseous medium. In particular, the device is capable of measuring the effects of physical and/or chemical parameters, causing changes in density and/or compression constants of a medium, for instance, due to temperature and pressure changes in biochemical and physical reactions on the density of a medium.

It is a known fact that changes in temperatures and pressures are detected by conventional means for measuring temperature and pressure. However, these means will fail when a medium is not accessible or is in an environment, in which no measuring devices can be introduced. In addition, these changes are frequently so minute that very expensive measuring devices are required for detection.

In many cases, changes in temperature and/or pressure are only an indication to the user that a medium has reached a desired property, for instance, that oil has the required viscosity, that sensitive deep-frozen products have thawed, that a process is taking or has taken place etc. Temperature and/or pressure measurements are therefore used for setting or ascertaining a specific quality of a solid, liquid or gaseous medium.

When an extremely accurate determination of changes is to be made or a specific property of a medium is to be determined with high accuracy, when sudden changes occur and rapid changes are to be measured, all prior art measuring methods will fail. A new method is therefore required by which such events are determined.

It is therefore the task of the present invention to suggest a device, by which a change in the structural properties of a solid, liquid or gaseous medium may be determined with high accuracy and at high speed. The device should also be suitable for determining the structural properties of media in sealed containers that are inaccessible or hard to access. The task is solved by the characteristics of the attached patent claims. The device for detecting changes in the density of a medium comprises a transmitter unit for transmitting a send signal having a constant frequency and amplitude, with the send signal comprising a minimum of one period and the transmitter unit being coupled to the medium. For the reception of reflected and/or transmitted response signals from a medium, at least one receiver unit is provided. The receiver unit is coupled to an A/D converter and a sampling unit. The transmitter unit and the output of the A/D converter is linked to a numerical processing unit for detecting the phase shift between the send signal and the receive signal, the output of which is connected to a display. The display may also be replaced by a memory unit for providing at a later date, the time characteristics of any changes in density data.

In a preferred design, the send signal has a sine shape, whereas in another design the send signal is an acoustic signal. The device may be used, for instance, in an ultrasonic area.

In an advantageous embodiment, the design of the transmitter unit allows the transmission of two send signals of different frequencies, with the signal propagation time of the send signals differing by a maximum of one period. For the selection of send signal frequencies, an approximate idea of the length and propagation speed of the send signal in the medium will suffice. The fact that send signals only differ by one period over their propagation time is used for the accurate determination of the signal propagation time through the medium.

The transmitter and the receiver unit may be designed as a reversible sensor. In this case, the maximum length of the send signal is equal to twice the distance between the sensor and the reflection point of the send signal in the medium.

Initially, the function is described for a case in which the length, that is the path of the send signal between the transmitter and the receiver unit is known and constant, where:

ΔTₚ=L/Δν

Tₚ is the propagation time through the medium and ν the speed of the signal.

A signal of a frequency ƒ₁, depending on the medium and the transmitter, is transmitted. The receive signal is sampled by a sampling frequency of ƒₛₐₘₚ at

$${f}_{samp} = \frac{n}{m} {f}_{1}$$

with m,nεN.

When using a reversible transmitter/receiver within the path 2L, a multiple of the send signal period and a multiple of the sampling signal period must agree.

Ex.: ƒₛₐₘₚ=3.5 ƒ₁ [symbol] 2 ƒₛₐₘₚ=7f₁)

The sampling frequency ƒₛₐₘₚ may be smaller than, equal to or larger than the Nyquist frequency of the send signal. m and n are limited by the path L and the trancducer characteristics.

Initially, the reference propagation time Tₓ it determined by measuring the phase shift φₓ between the send signal and the receive signal when the send signal passes through the medium in reference condition. In order to measure φₓ, for instance, 7 sampling points (corresponding to 2 periods of the send signal) are selected. This results in

$${T}_{x} = \frac{{ϕ}_{x} + 2 π N}{2 π {f}_{1}}$$

where N is the number of full periods of the send signal within the signal path from the transmitter to the receiver.

As L is known, the reference speed νₓ, for instance, may be calculated by the formula

$${v}_{x} = \frac{L}{{T}_{x}}$$

When a change occurs in the physical properties of the medium, the speed and therefore the signal propagation time will change, as L is fixed. The phase shift φₚ is then measured again and the propagation time Tₚ may be determined from the difference between this and the previous phase shift, resulting in

$$Δ T = {T}_{p} - {T}_{x} = \frac{( {ϕ}_{p} - {ϕ}_{x} )}{2 π {f}_{1}} .$$

Changes in propagation time Tₚ[s] allow to draw conclusions of changes in physical properties of the medium. The ratio of

$$\frac{{T}_{p}}{{T}_{x}}$$

may be viewed and graphically displayed in the same manner in order to draw conclusions of changes in the medium. When required, the change in speed Δν of the signal in the medium may be calculated by

$$Δ v = \frac{L}{Δ T} .$$

When the length L, i.e. the path between the transmitter and the receiver unit is only “approximately” known and changeable and also the speed of the signal through the medium is approximately known, the mode of operation is as follows.

In order not to be dependent on L, two signals of different frequencies ƒ₁ and ƒ₂ will be transmitted. The following conditions apply:

L±ΔL

ΔL is negligible in view of changes in the physical properties of the medium in relation to the change Δν in the speed of the signal.

For the two send signals nƒ₁=mƒ₂ with |m−n|≦1 also applies, that is within the area subject to ultrasonic exposure, send signals of frequencies ƒ₁ and ƒ₂ differ by less than one period. This also means that the larger L+ΔL, the smaller must be the difference between the frequencies. The frequencies of the two signals are dependent on the medium, the transducer characteristic, the approximate length of the sound path and the approximate signal speed in the medium.

The following applies:

$${f}_{samp} = \frac{{n}_{1}}{{m}_{1}} {f}_{1} = \frac{{n}_{2}}{{m}_{2}} {f}_{2}$$

at n₁, n₂, m₁, m₂ ε [symbol] N

(Ex.: 2ƒₛₐₘₚ=7ƒ₁

2ƒₛₐₘₚ=6.5f₂ [symbol] 4ƒₛₐₘₚ=13ƒ₂).

Two send signals are transmitted in sequence and reflected and/or transmitted signals are sampled by a frequency ƒₛₐₘₚ, allowing in each case a multiple of a full period of the respective signal to be included in the received signals. In this case, the sampling frequency fₛₐₘₚ may be selected independently from the Nyquist frequency. For instance, 7 sampling points may correspond to 2 periods of the first send signal, having a frequency ƒ₁ and 13 sampling points to 4 periods of the second send signal, having a frequency ƒ₂), as shown in the above example.

Phases (φ_{E,1} and φ_{E,2} of signals received plus φ_{S,1} and φ_{S,2} of send signals are measured, followed by using the formula

$$N = - \frac{( {ϕ}_{E , 1} - {ϕ}_{S , 1} ) {f}_{2} - ( {ϕ}_{E , 2} - {ϕ}_{S , 2} ) {f}_{1}}{2 π ( {f}_{1} - {f}_{2} )}$$

for calculating the value for N (N corresponds to the number of full periods of the send signal having a frequency ƒ₁ within the measuring path). Another option would be to transmit the signals with a phase of 0° and only to measure the phases of the receive signals. This will simplify the above formula as follows:

$$N = - \frac{( {ϕ}_{E , 1} ) {f}_{2} - ( {ϕ}_{E , 2} ) {f}_{1}}{2 π ( {f}_{1} - {f}_{2} )} .$$

When N and the measured propagation time are known in reference or initial condition, respectively, of the medium Tₓ, a new propagation time Tₚ results from

$${T}_{p} = {T}_{x} - \frac{{ϕ}_{E , 1} - {ϕ}_{S , 1} + 2 π N}{2 π {f}_{1}} = {T}_{x} - \frac{{ϕ}_{E , 2} - {ϕ}_{S , 2} + 2 π N}{2 π {f}_{2}} .$$

When considering the change in propagation time Tₚ-Tₓ over time, this will also allow conclusions to changes in the physical properties of the medium. Should differences exist between both send signals ƒ₁ and ƒ₂, for instance, an average may be taken from the two values of Tₚ, resulting from calculations.

The path between the transmitter and the receiver unit is always decisive. When a strong echo exits, for instance, when opposing walls are parallel in the medium, the method should be used in reflection mode. When only one coupling point of the device to the medium exists in this case, a maximum echo signal may be simply found by minor shifts in the transmitter/receiver unit.

The method may be applied both to the area exposed to ultrasound and by means of electromagnetic waves.

The invention will be described in the following in detail by means of an embodiment.

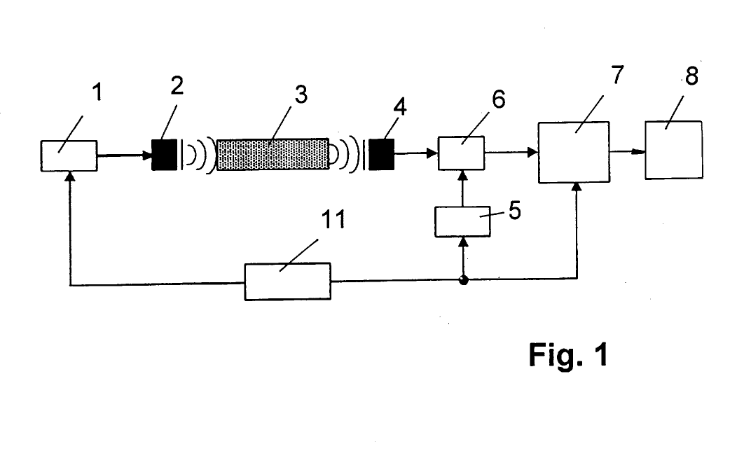

FIG. 1 shows the basic design of the present invention and

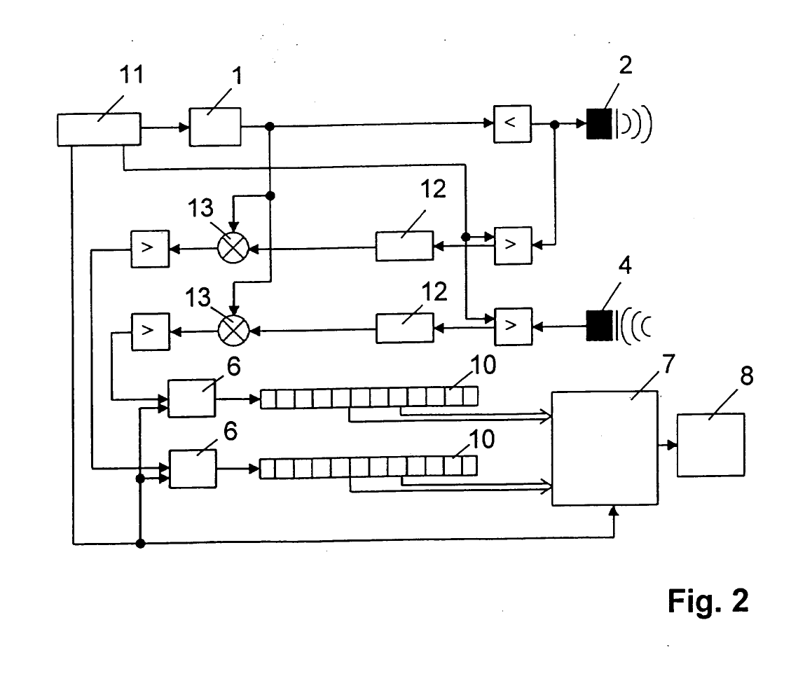

FIG. 2 shows one specific embodiment of the present invention.

FIG. 1 shows the basic structure of the device for detecting changes in the density of a medium. A generator 1 and a transmitter unit 2 generate a send signal of a constant frequency and amplitude, with the send signal having at least one period. The transmitter unit 2 is coupled to the medium 3. For reception of the reflected and/or transmitted response signals from the medium 3, at least one receiver unit 4 is available. The receiver unit 4 is controlled by a sampling device 5, followed by an A/D converter 6. The transmitter unit 2 and the output of the AID converter 6 are linked to a numerical processor 7 for determination of the phase shift between the send signal and the receive signal, the output of which is coupled to a display 8. It is also possible to connect a memory 9 in addition to or instead of the display. The change in the phase shift over a specific period of time may be used for retrospectively determining certain features of the medium.

For operation of this device, the length of the transmission path, i.e. the path of the send signal from the transmitter unit 2 through the medium 3 to the receiver unit 4 and the speed of the send signal through the medium 3 must be known.

FIG. 2 shows a device for detecting changes in the density of a medium 3, additionally equipped with a calibration unit. A generator 1 and a transmitter unit 2 are generating simultaneously or in quick succession two send signals of a constant frequency and amplitude, with the send signals comprising at least one period. The transmitter unit 2 is coupled to the medium 3. For receiving the reflected and/or transmitted response signals from the medium 3, a receiver unit 4 has been provided. The transmitter unit 2 and the receiver unit 4 are coupled to identical channels, in which the signals are conditioned in a manner that is prior art and are filtered in a filter 12. The signals are each mixed with a send signal in a mixer 13. Both channels are connected over a shift register 10, in which the digital values of the A/D converter 6 are stored, with a numerical processor 7 for determining the phase shift between the send signal and the receive signal of the two frequencies, the output of which is also coupled to a display 8 in this case.

This design is specifically suitable for applications in which the length of the path from the transmitter unit 2 through the medium 3 to the receiver unit 4 and the speed of the send signal through the medium 3 are only approximately known. For determination of the length of the path from the transmitter unit 2 to the receiver unit 4, two send signals of different frequencies are generated, subject to a maximum difference of one period only over the path from the transmitter unit 2 to the receiver unit 4. The length of the path from the transmitter unit 2 to the receiver unit 4 may by accurately determined by the numerical processor 7 from the phase shift, caused by these conditions lying within one period, as explained in the introduction. For the detection of further phase shifts between the send signal and the receive signal, both signals may then be used, although one of the signals may also be switched off.

1. Device for determining changes of the density of a medium, characterized by the presence of a transmitting device for the emission of a transmit signal having constant frequency and amplitude, whereby the transmitted signal has a minimum of one period and the transmitting, device is coupled with the medium for the reception of the reflected and/or transmitted response signals from the medium there is at least one receiver unit, of which each is coupled to an A/D converter and a sampling unit, whereby the transmitter unit and the output of the A/D converter is linked to a numerical processing unit for detecting the phase shift between the send signal and the receive signal, the output of which is connected to a display.

2. Device for determining changes of the density of a medium according to claim 1, in which the transmitted signal has a sine shape.

3. Device for determining changes of the density of a medium according to one of claim 2, in which the transmitted signal is an acoustic signal.

4. Device for determining changes of the density of a medium according to one of the claims 1 to 3, in which the transmitter unit allows the transmission of two send signals of different frequencies, with the signal propagation time of the send signals differing by a maximum of one period.

5. Device for determining changes of the density of a medium according to one of the claims 1 to 4, characterized by the fact that the transmitting and receiving devices consist of a single convertible sensor, and that the length of the transmitted signal is at the most equal to twice the distance between the sensor and the reflection point of the send signal in the medium.
